(19) United States
(12) Patent Application Publication
(10) Pub. No.: US 2020/0346331 A1
(43) Pub. Date: Nov. 5, 2020

(54) SNAP RING PLIERS

(71) Applicant: Jin Fu Chen, Dali City (TW)

(72) Inventor: Jin Fu Chen, Dali City (TW)

(21) Appl. No.: 16/403,059

(22) Filed: May 3, 2019

(51) Int. Cl. B25B 27/20

(52) U.S. Cl. CPC B25B 27/205

(57) ABSTRACT

Snap ring pliers include two levers, two posts, and two protruding blocks. The two levers are pivotally connected to each other and relatively pivotable. The two levers each have a control end at a distal end thereof. The two posts are fixed to the control ends of the two levers, respectively. The posts each have a complete surface without a notch. The posts each have a non-circular cross-section and at least one an arris for leaning against a perforation of a snap ring. The two protruding blocks are respectively fixed to distal ends of the two posts for restraining the snap ring from being separated from the posts, thereby controlling the snap ring stably.

### FIELD OF THE INVENTION

The present invention relates to a hand tool, and more particularly to a snap ring pliers.

### BACKGROUND OF THE INVENTION

A snap ring is generally used for the assembly and positioning of small mechanical components. The snap ring has a C-like shape with a slit, and can be deformed by snap ring pliers for the snap ring to be placed and positioned in a notch of the snap ring pliers.

FIG. 9 illustrates the structure of the distal end of conventional snap ring pliers. A post 81 extends outwardly from the end portion of the snap ring pliers 8. One side of the post 81 is provided with a notch 82 extending inwardly in a radial direction. When the snap ring is controlled by the snap ring pliers 8, the post 81 passes through the perforation of the snap ring, and the notch 82 is engaged with the edge of the perforation, such that the snap ring pliers 8 can control the snap ring stably.

However, the notch of the post 81 will cause the post 81 to be incomplete in structure, destroying the continuity of the forging flow line. As a result, the strength is lowered, and the post 81 may be cracked and damaged during use, so that the snap ring cannot be continuously controlled. Accordingly, the inventor of the present invention has devoted himself based on his many years of practical experiences to solve these problems.

### SUMMARY OF THE INVENTION

The primary object of the present invention is to provide snap ring pliers, which is able to control a snap ring reliably and stably, has better structural strength, and prevents structural cracks and damages.

In order to achieve the above object, snap ring pliers are provided. The snap ring pliers comprise two levers, two posts, and two protruding blocks. The two levers are pivotally connected to each other and relatively pivotable. The two levers each have a control end at a distal end thereof. The two posts are fixed to the control ends of the two levers, respectively. The posts each have a complete surface without a notch. The posts each have a non-circular cross-section and at least one an arris for leaning against a perforation of a snap ring. The two protruding blocks are respectively fixed to distal ends of the two posts for restraining the snap ring from being separated from the posts.

Preferably, the two levers each have an inner side and an outer side. The inner sides of the two levers are arranged in a face-to-face manner. The outer sides of the two levers are arranged in a back-to-back manner. The posts each slant outwardly relative to an axial direction of a corresponding one of the levers.

In an embodiment, the protruding blocks are disposed on axial end faces of the posts, respectively. The protruding blocks each has an oblique stop portion extending outwardly.

In an embodiment, the protruding blocks are disposed on axial end faces of the posts, respectively. The protruding blocks each has an oblique stop portion extending inwardly.

### BRIEF DESCRIPTION OF THE DRAWINGS

FIG. 1 is a perspective view in accordance with a first embodiment of the present invention;

FIG. 2 and FIG. 3 are partial enlarged views in accordance with the first embodiment of the present invention;

FIG. 4 is a schematic view in accordance with the first embodiment of the present invention when in use;

FIG. 5 is a cross-sectional view taken along line A-A of FIG. 4;

FIG. 6 is a partial enlarged view in accordance with a second embodiment of the present invention;

FIG. 7 is a cross-sectional view taken along line B-B of FIG. 6;

FIG. 8 is a schematic view in accordance with the second embodiment of the present invention when in use; and

FIG. 9 is a partial enlarged view of conventional snap ring pliers.

### DETAILED DESCRIPTION OF THE PREFERRED EMBODIMENTS

Embodiments of the present invention will now be described, by way of example only, with reference to the accompanying drawings.

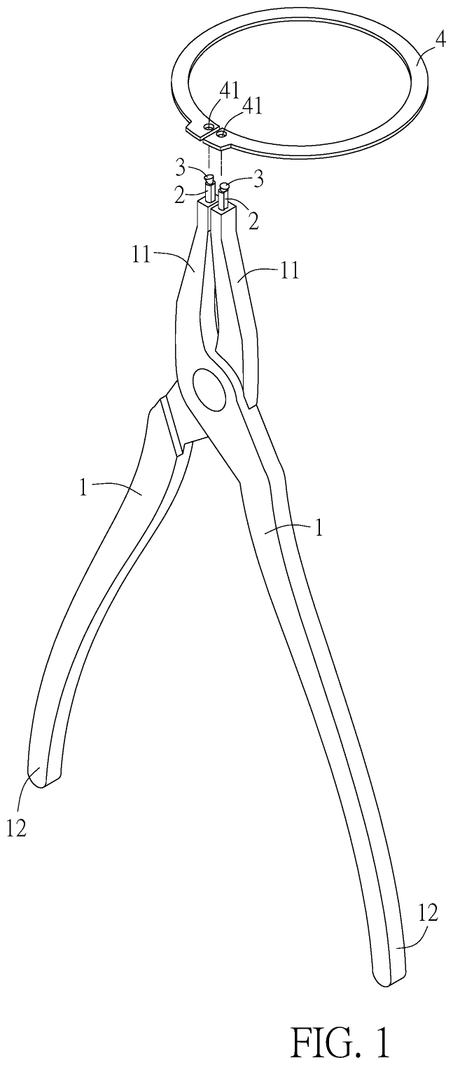

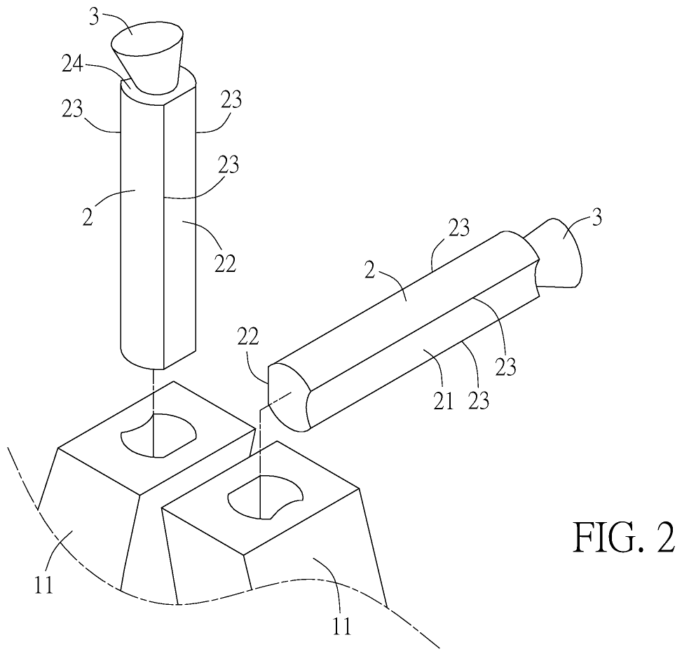

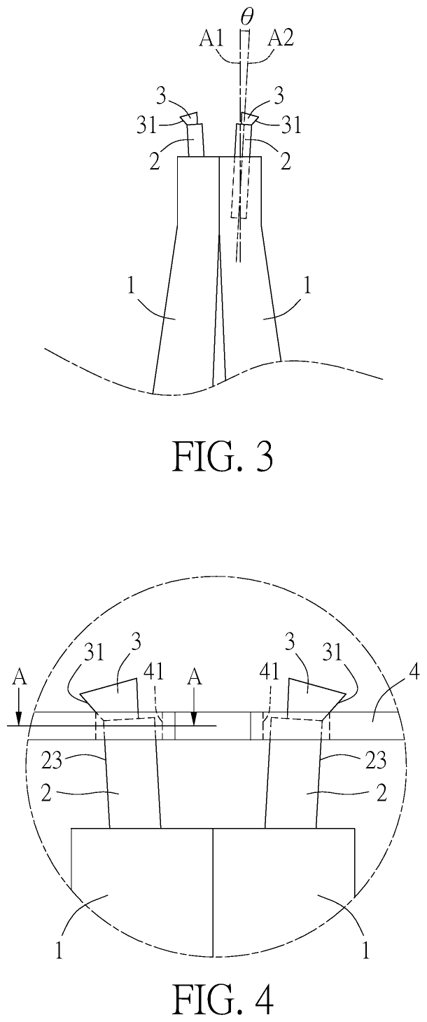

Referring to FIG. 1, FIG. 2 and FIG. 3, snap ring pliers in accordance with a first embodiment of the present invention comprise two levers 1 which are pivotally connected to each other and relatively pivotable. The two levers 1 each have a control end 11 at one end for controlling a snap ring and a handle end 12 at an opposite end for the user to grip and manipulate the snap ring pliers.

A post 2 is embedded and fixed to the control end 11 of each of the two levers 1. In this embodiment, the post 2 is formed by an extrusion molding process, thereby forming a forging flow line that is uninterrupted and along the length of the post 2, so that the structural strength of the post 2 is maintained. The cross-section of the post 2 is non-circular. In particular, the post 2 has a concave curved surface 21 at an outer side, a flat surface 22 at an inner side, and at least one an arris 23 for leaning against a perforation of the snap ring. The concave curved surfaces 21 of the two posts 2 are arranged in a back-to-back manner. The flat surfaces 22 of the two posts 2 are arranged in a face-to-face manner. The post 2 doesn't have a notch thereon to maintain the integrity of its surface, thereby consolidating its structural strength. The post 2 is disposed obliquely with respect to the corresponding lever 1. In detail, the two levers 1 each have an inner side and an outer side. The inner sides of the two levers 1 are arranged in a face-to-face manner. The outer sides of the two levers 1 are arranged in a back-to-back manner. The post 2 is disposed in an axial direction A2 which is inclined outwardly by an angle θ relative to an axial direction A1 of a corresponding one of the levers 1.

A protruding block 3 extending from a distal end of the post 2. In this embodiment, the axial distal end of the post 2 has an end face 24. The protruding block 3 is disposed on the end face 24 and has an oblique stop portion 31 extending outwardly. The oblique stop portions 31 of the two protruding blocks 3 extend toward the relative outer sides.

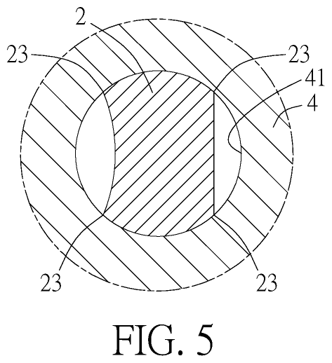

The structure of this embodiment is applicable to an example of use in which a snap ring 4 is to be opened. With the above structure, when in use, as shown in FIG. 4 and FIG. 5, the posts 2 of the two levers 1 are inserted in the perforations 41 of the snap ring 4, and the arris 23 is pressed against the edge of the corresponding perforation 41, and then the two levers 1 are pivoted to open, so that the snap ring 4 can be opened. At this time, the concave curved surface 21 of the post 2 leans against the edge of the corresponding perforation 41 to increase the contact area, so that the two posts 2 cooperatively hold the snap ring 4 without being detached easily. The snap ring 4 can be blocked by the two oblique stop portions 31 extending outwardly of the two protruding blocks 3, and is not pulled by the force of the outwardly opening of the two levers 1 to disengage from the posts 2, ensuring that the snap ring 4 can be controlled reliably and stably.

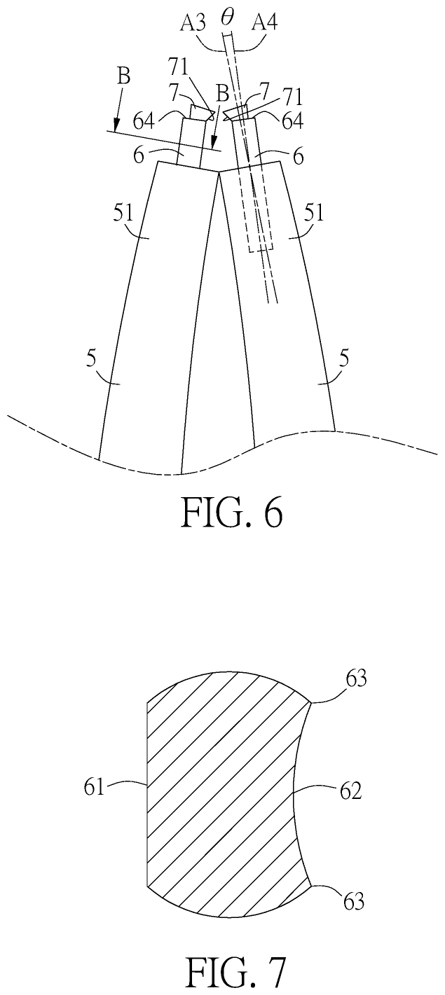

Referring to FIG. 6, snap ring pliers in accordance with a second embodiment of the present invention comprise two levers 5 which are pivotally connected to each other and relatively pivotable. The two levers 5 each have a control end 51 at one end for controlling a snap ring. A post 6 is embedded and fixed to the control end 51 of each of the two levers 5. In this embodiment, the post 6 is formed by an extrusion molding process, thereby forming a forging flow line that is uninterrupted and along the length of the post 6, so that the structural strength of the post 6 is maintained. The cross-section of the post 6 is non-circular. As shown in FIG. 7, the post 6 has a flat surface 61 at an outer side, a concave curved surface 62 at an inner side, and at least one an arris 63 for leaning against a perforation of the snap ring. The flat surfaces 61 of the two posts 6 are arranged in a back-to-back manner. The concave curved surfaces 62 of the two posts 6 are arranged in a face-to-face manner. The post 6 doesn't have a notch thereon to maintain the integrity of its surface, thereby consolidating its structural strength. The post 6 is disposed obliquely with respect to the corresponding lever 5. In detail, the two levers 5 each have an inner side and an outer side. The inner sides of the two levers 5 are arranged in a face-to-face manner. The outer sides of the two levers 5 are arranged in a back-to-back manner. The post 6 is disposed in an axial direction A4 which is inclined outwardly by an angle θ relative to an axial direction A3 of a corresponding one of the levers 5.

A protruding block 7 extending from a distal end of the post 6. In this embodiment, the axial distal end of the post 6 has an end face 64. The protruding block 7 is disposed on the end face 64 and has an oblique stop portion 71 extending inwardly. The oblique stop portions 71 of the two protruding blocks 7 extend toward the relative inner sides.

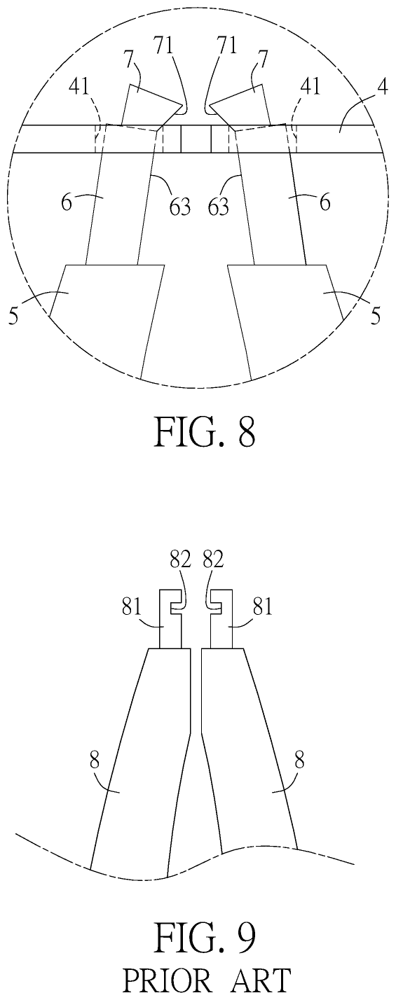

The structure of this embodiment is applicable to an example of use in which a snap ring 4 is to be opened. With the above structure, when in use, as shown in FIG. 8, the posts 6 of the two levers 5 are inserted in the perforations 41 of the snap ring 4, and the arris 63 is pressed against the edge of the corresponding perforation 41, and then the two levers 5 are pivoted to open, so that the snap ring 4 can be opened. At this time, the concave curved surface of the post 6 leans against the edge of the corresponding perforation 41 to increase the contact area, so that the two posts 6 cooperatively hold the snap ring 4 without being easily detached. The snap ring 4 can be blocked by the two oblique stop portions 71 extending inwardly of the two protruding blocks 7, and is not pulled by the force of the inwardly closing of the two levers 5 to disengage from the posts 6, ensuring that the snap ring 4 can be controlled reliably and stably.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. Snap ring pliers, comprising:
two levers, pivotally connected to each other and being relatively pivotable, the two levers each having a control end at a distal end thereof;
two posts, respectively fixed to the control ends of the two levers, the posts each having a complete surface without a notch, the posts each having a non-circular cross-section and at least one an arris for leaning against a perforation of a snap ring;
two protruding blocks, respectively fixed to distal ends of the two posts for restraining the snap ring from being separated from the posts.

2. The snap ring pliers as claimed in claim 1, wherein the posts are formed by an extrusion molding process.

3. The snap ring pliers as claimed in claim 1, wherein the two levers each have an inner side and an outer side, the inner sides of the two levers are arranged in a face-to-face manner, the outer sides of the two levers are arranged in a back-to-back manner; the posts each slant outwardly relative to an axial direction of a corresponding one of the levers.

4. The snap ring pliers as claimed in claim 3, wherein the protruding blocks are respectively disposed on axial end faces of the posts, and the protruding blocks each has an oblique stop portion extending outwardly.

5. The snap ring pliers as claimed in claim 4, wherein each of the posts has a concave curved surface at an outer side and a flat surface at an inner side, the concave curved surfaces of the posts are arranged in a back-to-back manner, and the flat surfaces of the posts are arranged in a face-to-face manner.

6. The snap ring pliers as claimed in claim 3, wherein the protruding blocks are respectively disposed on axial end faces of the posts, and the protruding blocks each has an oblique stop portion extending inwardly.

7. The snap ring pliers as claimed in claim 6, wherein each of the posts has a flat surface at an outer side and a concave curved surface at an inner side, the flat surfaces of the posts are arranged in a back-to-back manner, and the concave curved surfaces of the posts are arranged in a face-to-face manner.
